(19) United States
(12) Patent Application Publication
(10) Pub. No.: US 2005/0248709 A1
(43) Pub. Date: Nov. 10, 2005

(54) Flexible printed circuit film and liquid crystal display device including the same

(76) Inventor: Sin-Gu Kang, Suwon-si (KR)

Correspondence Address: CANTOR COLBURN, LLP, 55 GRIFFIN ROAD SOUTH, BLOOMFIELD, CT, 06002, US

(21) Appl. No.: 11/120,248

(22) Filed: May 2, 2005

(30) Foreign Application Priority Data
May 6, 2004 (KR) 10-2004-0031694

(51) Int. Cl. G02F 1/1345

(52) U.S. Cl. 349/150

(57) ABSTRACT

A flexible printed circuit includes a first conductive layer, a base film and a first cover layer. The base film supporting the first conductive layer and has a first contact hole and a second contact hole. The first cover layer covers the first conductive layer. The first conductive layer is interposed by the base film and the first cover layer except for portions exposed through the first and second contact holes.

This application claims priority to Korean Patent Application Nos. 10-2004-0031694, filed on May 6, 2004, the contents of which in its entirety are herein incorporated by reference.

### BACKGROUND OF THE INVENTION

(a) Field of the Invention

The present disclosure relates to a printed circuit film and a liquid crystal display including the same. More particularly, the present disclosure relates to a flexible printed circuit film and a liquid crystal display including the same.

(b) Description of the Related Art

Liquid crystal display (LCD) is one of the most widely used flat panel displays. LCD devices include two panels provided with field-generating electrodes, and a liquid crystal (LC) layer interposed between the two panels. The LCD devices may have switching elements to control pixel voltages of pixels arranged in a matrix form on one of the two panels. The LCD devices display images by changing pixel voltages, which are individually controlled. An LCD device having switching elements to control pixel voltages individually is called an active matrix LCD device.

An LCD device displays images by applying voltages to the field-generating electrodes to generate an electric field in the LC layer, which determines orientations of LC molecules in the LC layer to adjust polarization of incident light. However, due to characteristics of the LC layer, applying the electric field in the LC layer for a long time may damage the LC layer. To prevent the LC layer from being damaged, a polarity of data signal voltages is inverted with respect to a common electrode voltage for each alternating frame, for every pixel or pixel row.

In order to drive such an LCD device, driving integrated circuits (ICs) are provided. Driving ICs generally include data driving ICs and gate driving ICs. Tape automated bonding (TAB) is generally used to electrically connect the driving ICs to the LCD device. Tape carrier package (TCP) and chip on film (COF) are most often used in TAB. TAB includes films having driving ICs thereon connected to both a printed circuit board (PCB) having driving circuits and an LC panel including the two panels and the LC layer. Thus, inputs of the driving ICs are connected to the PCB and the outputs of the driving ICs are connected to the LC panel.

The driving ICs fitted by the TAB may be easily damaged by external impacts. In order to prevent such damage of the driving ICs, a chip on glass (COG) method has come into use. COG is a fitting method in which the driving ICs are directly fitted on the LC panel.

However, even when the COG is applied, flexible printed circuits (FPCs) are often used to connect the driving ICs to the PCB. Accordingly, an LCD device manufactured by COG is not free from defects that may be induced by external impact. The FPCs may be bent to expose the PCB on a back side of the LC panel. During such exposure, conductive thin layers disposed in the FPC may be damaged or disconnected.

### SUMMARY OF THE INVENTION

The present invention provides a FPC that gets less damage during connecting the driving ICs to the LC panel and an LCD device including the same.

The present invention provides a FPC having a base film and cover layers completely enclosing signal lines and supporting the signal lines at the bending portion.

In detail, the present invention provides a FPC comprising: a first conductive layer; a base film supporting the first conductive layer and having a first and second contact holes; and a first cover layer covering the first conductive layer, wherein the first conductive layer is interposed between the base film and the first cover layer.

The FPC may further comprise a second conductive layer connected to the first conductive layer through the first contact hole and acting as an output terminal of the FPC.

The FPC may further comprise a third conductive layer connected to the first conductive layer through the second contact hole; and a second cover layer disposed proximate to the third conductive layer to interpose the third conductive layer along with the base film.

The third conductive layer may be disposed on an opposite side of the base film as the first conductive layer. The second conductive layer may be disposed on an opposite side of the base film as the first conductive layer.

The present invention provides an LCD device comprising: the FPC described above; a first panel having gate lines and data lines, at least one of the gate and data lines being electrically connected to the first conductive layer; a second panel facing the first panel; and a liquid crystal layer disposed between the first and second panels.

The first and second panels include a pixel electrode and a common electrode, respectively, and a thin film transistor, the pixel and common electrodes being disposed to face each other, and the thin film transistor having first to third terminals connected to one of the gate lines, one of the data lines, and the pixel electrode, respectively.

### BRIEF DESCRIPTION OF THE DRAWINGS

Preferred embodiments of the present invention can be understood in more detail from the following descriptions taken in conjunction with the accompanying drawings, in which:

FIG. 1 shows a block diagram of a liquid crystal display (LCD) device according to an exemplary embodiment of the present invention;

FIG. 2 is an equivalent circuit view of a pixel unit of an LCD device according to an exemplary embodiment of the present invention;

FIG. 3 is a layout view of a panel portion of an LCD device according to an exemplary embodiment of the present invention; and

FIG. 4 is a cross-sectional view of the LCD device shown in FIG. 3 taken along line IV-IV′.

### DETAILED DESCRITPION OF THE INVENTION

Preferred embodiments of the present invention will be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a flexible printed circuit (FPC) and a liquid crystal display (LCD) device having the same according to preferred embodiments of the present invention will be described in detail with reference to the accompanying drawings.

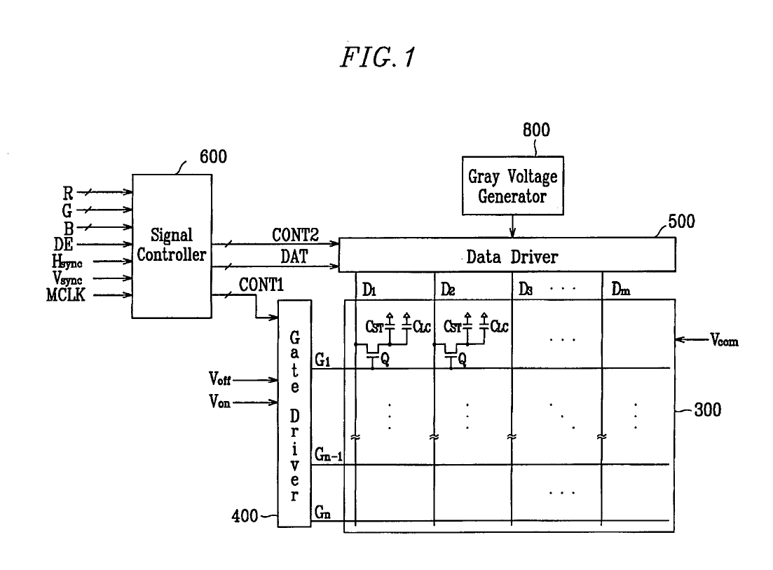

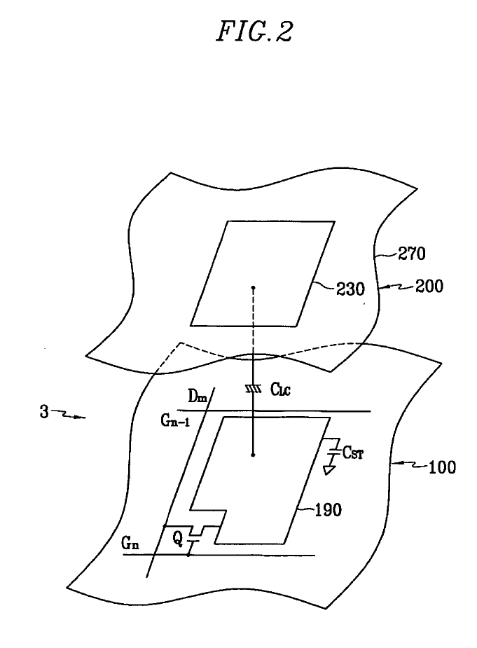

FIG. 1 shows a block diagram of a LCD device according to an exemplary embodiment of the present invention. FIG. 2 is an equivalent circuit view of a pixel unit of an LCD device according to an exemplary embodiment of the present invention.

Referring to FIG. 1, an LCD device according to this embodiment of the present invention comprises an LC panel assembly 300, a gate driver 400 and a data driver 500 which are connected to the LC panel assembly 300, a gray voltage generator 800 connected to the data driver 500, and a signal controller 600 for controlling the above elements.

The LC panel assembly 300 includes a lower panel 100 and an upper panel 200 facing each other. The LC panel assembly 300 includes a plurality of display signal lines G₁-Gₙ and D₁-Dₘ and pixels connected thereto and arranged substantially in a matrix.

The display signal lines G₁-Gₙ and D₁-Dₘ are provided on a lower panel 100 and include gate lines G₁-Gₙ for transmitting gate signals (also referred to as “scanning signals”), and data lines D₁-Dₘ for transmitting data signals. The gate lines G₁-Gₙ extend substantially in a row direction and are substantially parallel to each other, while the data lines D₁-Dₘ extend substantially in a column direction and are substantially parallel to each other.

Each of the pixels includes a switching element Q, which is connected to selected ones of the display signal lines G₁-Gₙ and D₁-Dₘ, and a LC capacitor C_{LC} and a storage capacitor C_{ST} which are connected to the switching element Q. The storage capacitor C_{ST} may be omitted.

The switching element Q, such as a thin film transistor (TFT), is provided on the lower panel 100 and has three terminals: a control terminal electrically connected to one of the gate lines G₁-Gₙ; an input terminal electrically connected to one of the data lines D₁-Dₘ; and an output terminal electrically connected to both the LC capacitor C_{LC} and the storage capacitor C_{ST}.

The LC capacitor C_{LC} has a first terminal that includes a pixel electrode 190 provided on the lower panel 100 and a second terminal that includes a common electrode 270 provided on an upper panel 200. The LC layer 3 interposed between the pixel and common electrodes 190 and 270 functions as dielectric of the LC capacitor C_{LC}. The pixel electrode 190 is electrically connected to the switching element Q, and the common electrode 270 is supplied with a common voltage V_{com}, and covers an entire surface of the upper panel 200. As an alternative to the embodiment shown in FIG. 2, the common electrode 270 may be provided on the lower panel 100. In such a case, at least one of the pixel electrode 190 and the common electrode 270 may include a bar or a stripe shape.

The storage capacitor C_{ST} is an auxiliary capacitor for the LC capacitor C_{LC}. When the pixel electrode 190 and a separate signal line (not shown) which is provided on the lower panel 100 are overlapped with each other, interposing an insulator therebetween, the overlap portion becomes the storage capacitor C_{ST}. The separate signal line is supplied with a predetermined voltage such as the common voltage V_{com}. Alternatively, the storage capacitor C_{ST} may be formed by overlapping of the pixel electrode 190 and a previous gate line, which is placed directly before the pixel electrode 190, interposing an insulator therebetween.

For a color display, each pixel uniquely exhibits one of three primary colors (i.e., spatial division), or sequentially exhibits three primary colors in turn depending on time (i.e., temporal division), so that spatial or temporal sum of the primary colors is recognized as a desired color. FIG. 2 shows an example of the spatial division in which each pixel includes a color filter 230 for exhibiting one of the primary colors in an area of the upper panel 200 corresponding to the pixel electrode 190. Unlike FIG. 2, the color filter 230 may be provided on or under the pixel electrode 190 of the lower panel 100.

Polarizers (not shown) are provided on outer surfaces of the lower and upper panels 100 and 200 for polarizing the light.

The gray voltage generator 800 generates two sets of gray voltages related to a transmittance of the pixels. The gray voltages in a first set have a positive polarity with respect to the common voltage V_{com}, while of the gray voltages in a second set have a negative polarity with respect to the common voltage V_{com}.

The gate driver 400 may be employed via an integrated circuit (IC) chip, which is electrically connected to the gate lines G₁-Gₙ of the LC panel assembly 300 for transmitting the gate signals consisting of combinations of gate-on voltages Vₒₙ and gate-off voltages V_{off} input from an external device to the gate lines G₁-Gₙ.

The data driver 500 may be employed via an IC chip, which is electrically connected to the data lines D₁-Dₘ of the LC panel assembly 300 for transmitting data voltages which are selected from the gray voltages supplied from the gray voltage generator 800, to the data lines D₁-Dₘ.

ICs having the gate and data drivers 400 and 500 may be mounted on TCPs (tape carrier packages)(not illustrated) which are attached to the LC panel assembly 300. However, in the present invention, the ICs having the gate and data drivers 400 and 500 are directly mounted on the lower panel 100 without using TCP (i.e. chip on glass: COG). This will be described in detail below. Meanwhile, the gate driver 400 or the data driver 500 may be integrated into the lower panel 100 along with other elements.

The signal controller 600 is disposed on a PCB for controlling operation of the gate driver 400 and the data driver 500.

Hereinafter, the operation of the above-mentioned LCD device will be described in detail.

The signal controller 600 receives input image signals R, G, and B and input control signals for controlling the display thereof such as a vertical synchronizing signal V_{sync}, a horizontal synchronizing signal H_{sync}, a main clock MCLK, a data enable signal DE, etc. from an external graphic controller (not shown). In response to the input image signals R, G, and B and the input control signals, the signal controller 600 processes the input image signals R, G, and B suitably for operation of the LC panel assembly 300 and generates gate control signals CONT1 and data control signals CONT2, and then outputs the gate control signals CONT1 and the data control signals CONT2 to the gate driver 400 and the data driver 500, respectively.

The gate control signals CONT1 include a vertical synchronizing start signal STV for informing the gate driver 400 of a beginning of a frame, a gate clock signal CPV for controlling an output time of the gate-on voltage Vₒₙ, and an output enable signal OE for defining a duration of the gate-on voltage Vₒₙ.

The data control signals CONT2 include a horizontal synchronizing start signal STH for informing the data driver 500 of a beginning of a data transmission, a load signal LOAD for instructing the data driver 500 to apply the data voltages to the data lines D₁-Dₘ, a reverse control signal RVS for reversing a polarity of the data voltages with respect to the common voltage V_{com}, and a data clock signal HCLK.

Responsive to the data control signals CONT2 from the signal controller 600, the data driver 500 successively receives image data DAT for a row of pixels from the signal controller 600, shifts them, converts the image data DAT into analog data voltages selected from the gray voltages from the gray voltage generator 800, and then applies the data voltages to data lines D₁-Dₙ.

The gate driver 400 applies the gate-on voltage Vₒₙ to selected gate lines G₁-Gₙ in response to the gate control signals CONT1 from the signal controller 600, thereby turning on selected ones of the switching elements Q connected to the gate lines G₁-Gₙ. The data voltages applied to the data lines D₁-Dₘ are applied to corresponding pixels through turned-on switching elements Q.

The difference between the data voltages applied to the pixel and the common voltage V_{com} is represented as a voltage across the LC capacitor C_{LC}, namely, a pixel voltage. The LC molecules in the LC capacitor C_{LC} have orientations depending on a magnitude of the pixel voltage. Polarization of light is varied according to orientations of the LC molecules. The polarizer converts a difference of light polarization into a difference of light transmittance.

By repeating the above-described procedure each horizontal period (denoted by “1H” and equal to one period of the horizontal synchronizing signal H_{sync}, the data enable signal DE, and the gate clock CPV), all gate lines G₁-Gₙ are sequentially supplied with the gate-on voltage Vₒₙ during a frame, thereby applying the data voltages to corresponding pixels. When a next frame starts after finishing one frame, the reverse control signal RVS applied to the data driver 500 is controlled such that the polarity of the data voltages is reversed with respect to that of a previous frame (which is referred to as “frame inversion”). The reverse control signal RVS may be also controlled such that the polarity of the data voltages flowing in a data line in one frame are reversed (for example, line inversion and dot inversion), or the polarity of the data voltages in one packet are reversed (for example, column inversion and dot inversion).

Hereinafter, an LCD device manufactured by applying COG according to an embodiment of the present invention will be described in detail.

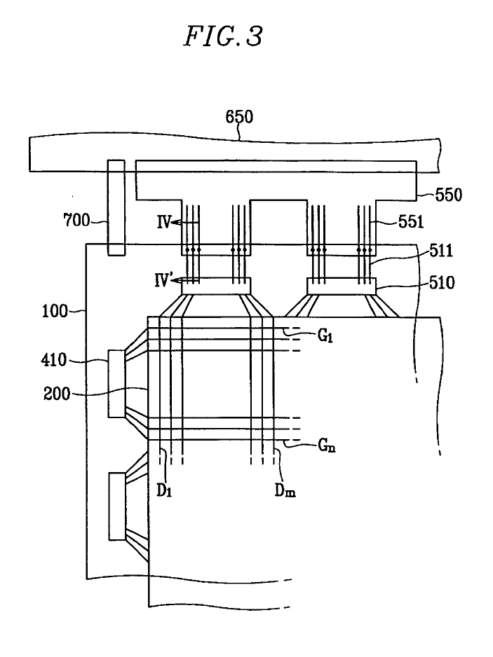

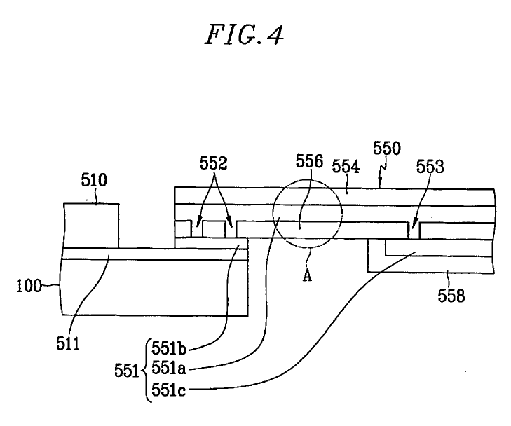

FIG. 3 is a layout view of a panel portion of an LCD device according to an exemplary embodiment of the present invention. FIG. 4 is a cross-sectional view of the LCD device shown in FIG. 3 taken along line IV-IV′.

Referring to FIGS. 3 and 4, an LCD device manufactured by applying COG according to an embodiment of the present invention includes the lower panel 100 on which the pixel electrodes 190 (see FIG. 2), the gate lines G₁-Gₙ, the data lines D₁-Dₘ, and the switching element Q are formed, the upper panel 200 facing the lower panel 100, gate driving ICs 410 disposed on the lower panel 100 and having output terminals connected to the gate lines G₁-Gₙ, data driving ICs 510 disposed on the lower panel 100 and having output terminals connected to the data lines D₁-Dₘ, an FPC 550 having wires connected to the input terminals of the data driving ICs 510, and a PCB 650 electrically connected to the lower panel 100 via the FPC 550. It should be noted that although FIG. 3 shows the PCB 650 electrically connected to data driving ICs on the lower panel 100 via the FPC 550, a separate PCB may be connected to the lower panel via gate driving ICs on the lower panel via a separate FPC.

In an exemplary embodiment, the lower panel 100 has a plurality of first signal lines 511 connecting the input terminals of the data driving ICs 510 to the output terminals of the FPC 550. The FPC 550 has a plurality of second signal lines 551 connected to the first signal lines 511. The first signal lines 511 are preferably made of a same material as the gate lines G₁-Gₙ or the data lines D₁-Dₘ.

Each FPC 550 includes the second signal lines 551, a base film 556 supporting the second signal lines 551, a first cover layer 554 and a second cover layer 558. The first and second cover layers 554 and 558 cover the second signal lines 551 to prevent the second signal lines 551 from being damaged by external impact and corrosion.

The second signal lines 551 include a first to third conductive layer 551a, 551b, and 551c, respectively. The first cover layer 554 is disposed on the base film 556 and interposes the first conductive layer 551a along with the base film 556. The second cover layer 558 is disposed under the base film 556 and interposes the third conductive layer 551c along with the base film 556. The second conductive layer 551b is connected to the first conductive layer 551a through a first contact hole 552 and is connected to the first signal lines 511 of the lower panel 100 as an output terminal of the FPC 550. The first conductive layer 551a and the third conductive layer 551c are connected to each other through a second contact hole 553 to form a supplemental double structure for preventing disconnection of the second signal lines 551 from the first signal lines 511.

In the FPC 550 according to an embodiment of the present invention, the base film 556 and the first and second cover layers 554 and 558 interpose the first and third conductive layer 551a and 551c, respectively. For example, the base film 556 and the first cover layer 554 interpose the first conductive layer 551a to ensure that the first conductive layer 551a is not exposed to an exterior at portion “A” where the FPC may be bent. Additionally, the base film 556 supports the first conductive layer 551a. Accordingly, the first conductive layer 551a is prevented from being damaged if the FPC 550 is bent.

An LCD device having the FPC according to an embodiment of the present invention was manufactured and tested. During testing the second signal lines 551 are not disconnected from the first signal lines 511. In particular the first conductive layer 551a is not disconnected even if the FPC 550 is bent 180 degrees at the portion A. Furthermore, the FPC 550 is not damaged by heat impact, vibration impact, and suspending.

A separate FPC 700 having signal lines for transmitting signals, such as gate-on and gate-off signals Vₒₙ and V_{off}, to the gate driving ICs 410 may be provided. Alternatively, such signal lines may be disposed on the FPC 550 along with other signal lines and the separate FPC 700 may be omitted. As stated above, a separate PCB for transmitting gate signals, such as gate-on and gate-off signals Vₒₙ and V_{off}, to the gate driving ICs 410 may be introduced. If a separate PCB is introduced, then another separate FPC for connecting the separate PCB to the gate driving ICs 410 may be required.

As described above, since the FPC according to an embodiment of the present invention has a base film and cover layers completely enclosing signal lines and supporting the signal lines at a bending portion such that the signal lines are prevented from being broken during manufacturing of an LCD device. Although exemplary embodiments have been described herein with reference to the accompanying drawings, it should be understood that the present invention is not limited to those precise embodiments, and that various changes and modifications may be affected therein by one of ordinary skill in the related art without departing from the scope or spirit of the invention. All such changes and modifications are intended to be included within the scope of the invention as defined by the appended claims.

1. A flexible printed circuit comprising:
a first conductive layer;
a base film supporting the first conductive layer and having a first contact hole and a second contact hole; and
a first cover layer covering the first conductive layer,
wherein the first conductive layer is interposed between the base film and the first cover layer.

2. The flexible printed circuit of claim 1, further comprising a second conductive layer connected to the first conductive layer through the first contact hole and acting as an output terminal of the flexible printed circuit.

3. The flexible printed circuit of claim 2, further comprising:
a third conductive layer connected to the first conductive layer through the second contact hole; and
a second cover layer disposed proximate to the third conductive layer to interpose the third conductive layer along with the base film.

4. The flexible printed circuit of claim 3, wherein the third conductive layer is disposed on an opposite side of the base film as the first conductive layer.

5. The flexible printed circuit of claim 3, wherein the second conductive layer is disposed on an opposite side of the base film as the first conductive layer.

6. The flexible printed circuit of claim 3, wherein the second conductive layer and the third conductive layer are spaced apart from each other.

7. A liquid crystal display (LCD) device comprising:
a flexible printed circuit comprising:
a first conductive layer;
a base film supporting the first conductive layer and having a first contact hole and a second contact hole; and
a first cover layer covering the first conductive layer, the first conductive layer being inteposed by the base film and the first cover layer;
a first panel having gate lines and data lines, at least one of the gate and data lines being electrically connected to the first conductive layer;
a second panel facing the first panel; and
a liquid crystal layer disposed between the first and second panels.

8. The LCD device of claim 7, wherein the first and second panels include a pixel electrode and a common electrode, respectively, and a thin film transistor, the pixel and common electrodes being disposed to face each other, and the thin film transistor having a first terminal, a second terminal and a third terminal connected to one of the gate lines, one of the data lines, and the pixel electrode, respectively.

9. The LCD device of claim 7, wherein the flexible printed circuit further comprises a second conductive layer connected to the first conductive layer through the first contact hole and acting as an output terminal of the flexible printed circuit.

10. The LCD device of claim 9, wherein the flexible printed circuit further comprises:
a third conductive layer connected to the first conductive layer through the second contact hole.

11. The LCD device of claim 10, wherein the flexible printed circuit further comprises:
a second cover layer disposed proximate to the third conductive layer to interpose the third conductive layer along with the base film.

12. The LCD device of claim 11, wherein the third conductive layer is disposed on an opposite side of the base film as the first conductive layer.

13. The LCD device of claim 11, wherein the second conductive layer is disposed on an opposite side of the base film as the first conductive layer.

14. The LCD device of claim 11, wherein the second conductive layer and the third conductive layer are spaced apart from each other.

15. The LCD device of claim 11, wherein the first panel includes a gate driving integrated circuit having output terminals electrically connected to the gate lines and input terminals electrically connected to the second conductive layer.

16. The LCD device of claim 11, wherein the first panel includes a data driving integrated circuit having output terminals electrically connected to the data lines and input terminals electrically connected to the second conductive layer.

17. The LCD device of claim 7, further comprising a printed circuit board having driving circuits connected to the first panel via the flexible printed circuit.
